(19) United States
(12) Patent Application Publication
(10) Pub. No.: US 2014/0298625 A1
(43) Pub. Date: Oct. 9, 2014

(54) Ornamental Attachment Device

(71) Applicants: Jaime Bach Gual, Barcelona (ES); Jorge David Caba Jimenez, Madrid (ES)

(72) Inventors: Jaime Bach Gual, Barcelona (ES); Jorge David Caba Jimenez, Madrid (ES)

(21) Appl. No.: 14/130,739

(22) PCT Filed: Apr. 27, 2012
(86) PCT No.: PCT/ES2012/070290

§ 371 Date: Apr. 3, 2014

(30) Foreign Application Priority Data
Jul. 8, 2011 (ES) U201130741

(51) Int. Cl. F16B 1/00

(52) U.S. Cl. CPC F16B 1/00; F16B 2001/0035
USPC 24/303

(57) ABSTRACT

The invention relates to an ornamental attachment device that can be used in particular for flat surfaces, which includes a main body that has at least one ornamental sheet and one metal sheet joined to each other on one of the sides thereof, said main body being joined in a detachable manner to magnetic attachment means arranged on a surface to be decorated, supporting means fixed to the surface to be decorated having being provided on the ends of the main body such that said main body remains locked in position.

### OBJECT OF THE INVENTION

The purpose of the invention patent application herein is to register an ornamental attachment device that incorporates significant innovations and advantages.

More specifically, the invention relates to a device that can be used in particular for flat surfaces, including a main body attached to said surface by means of magnetic means.

### BACKGROUND OF THE INVENTION

In the sector of interior design, ornamental elements used to provide rooms and spaces with an improved visual appearance are known. These known elements are generally applied on walls or ceilings of rooms or bedrooms that do not require special protection, but their configuration is not intended for use in bathrooms or kitchens, where environmental conditions are more aggressive and require frequent cleaning with water and detergents. Neither are they used on floors due to their brittleness.

In view of the foregoing, toilets and kitchens are decorated with moisture-resistant elements and which detergents can be applied to for effective cleaning. These elements are usually wall tiles and floor tiles characterised by being difficult to install, requiring the building work to be undertaken for installation with the drawbacks this involves. In addition, when the user wants to change the decor of the room, building work is required to remove old items and to proceed with the installation of the new items.

### DESCRIPTION OF THE INVENTION

The invention herein has been developed with the aim of providing an ornamental attachment device that resolves the aforementioned drawbacks, providing, in addition, other additional advantages that will become apparent from the description appended hereinafter.

It is therefore an object of this invention to provide an ornamental attachment device that can be used in particular for flat surfaces, which is characterised in that it comprises a main body that has at least one ornamental sheet and one metal sheet joined to each other on one of the sides thereof, said main body being joined in a detachable manner to magnetic attachment means arranged on a surface to be decorated, support means fixed to the surface to be decorated having being provided on the ends of the main body such that said main body remains locked in position.

Thanks to these characteristics, an ornamental attachment device is achieved that can be easily and quickly installed that requires no building work for installation or replacement. In addition to its configuration, it can be used in any room or bedroom, either on horizontal and vertical surfaces and assembly thereof offering great versatility, and on the other hand, it can also be cleaned with detergents for optimum hygiene.

Advantageously, said ornamental sheet is made of laminated glass, corian or marble and, in turn, said metal sheet is made of a ferric material, in order to attract the magnetic means.

According to one characteristic of the invention, said metal sheet has a number of laminar appendages at its ends, perpendicular to the main body, such that the contact surface between the main body and said support means increases.

Preferably, said magnetic means have a plurality of magnetic elements suitable for attaching to the surface to be decorated, each one of said magnetic elements being connected to the respective fixing plates by means of a threaded rod. Said fixing plates have at least one hole that can house a bolting element.

The support means comprise at least one skirting attached to the surface to be decorated with a plurality of bolting elements. Said skirting has a trim element snapped in place on its front side.

According to an additional characteristic of the invention, said main body may have a plurality of holes configured to allow the butt ends of the service conduits to pass through. Said main body is further configured such as to allow service conduits to pass between the same main body and the surface to be decorated.

Other characteristics and advantages of the ornamental attachment device object of the invention herein will become apparent from the description of a preferred, although not exclusive embodiment, which is illustrated by way of non-limiting example in the drawings appended, in which:

### BRIEF DESCRIPTION OF THE DRAWINGS

FIG. 1.—Cross-sectional view of an attachment device installed on a vertical surface according to the invention;

FIG. 2.—Perspective view of a portion of the attachment device of FIG. 1; and

FIG. 3.—Exploded view of magnetic means.

### DESCRIPTION OF A PREFERRED EMBODIMENT

As shown in the accompanying figures, a preferred embodiment of an ornamental attachment device according to the invention herein is seen.

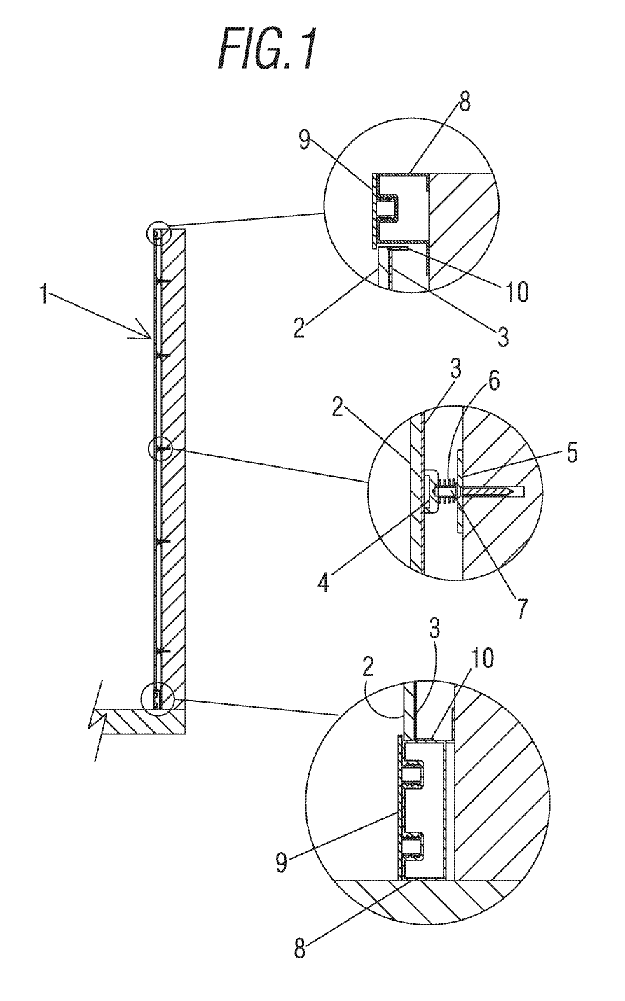

There are a number of enlarged details of the cross section of the attachment device in FIG. 1, to provide a better understanding of the invention.

As seen in FIG. 1, the ornamental attachment device comprises a main body 1 having one ornamental sheet 2 and one metal sheet 3 joined together permanently on one of the sides thereof, such that they constitute one unit. Preferably, the ornamental sheet 2 is made of laminated glass, which can be decorated based on the ornamental requirements, although it will be possible to replace the laminated glass for corian, marble or any similar material.

Said main body 1 is joined in a detachable manner to magnetic attachment means arranged on a surface to be decorated. This is why the metal sheet 3 is made of ferric material compatible with magnetic means, such that the main body 1 can be easily detached. Thanks to this characteristic, the main body 1 can be replaced without having to carry out building work in the room or bedroom, thereby quickly updating the look.

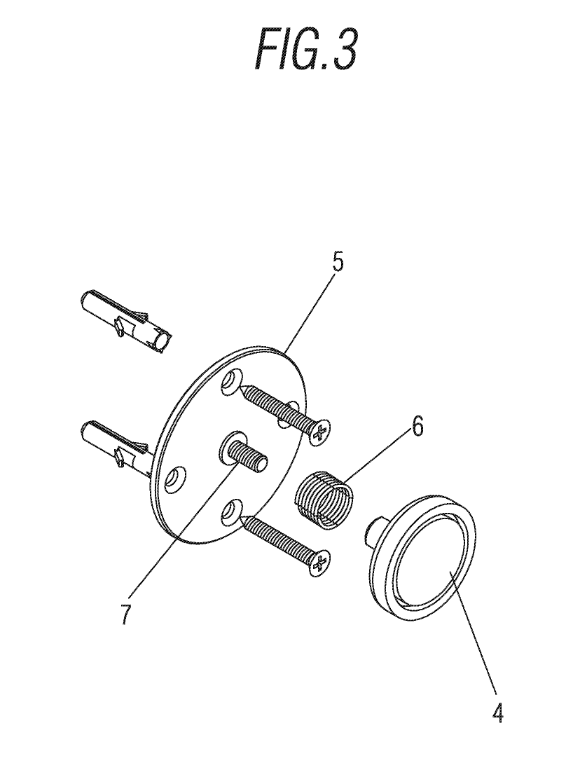

As can be seen in further detail in FIG. 3, the magnetic means have a plurality of magnetic elements 4 suitable for attaching to the surface to be decorated, each one of said magnetic elements 4 being connected to the respective fixing plates 5 by means of a threaded rod 7 by way of a guide. By using these adjustable threaded rods 7 constant contact can be maintained between the main body 1 and the magnetic elements 4, regardless of the irregularities the surface to decorated may have. A bushing and an elastic spring 6 can also be axially fitted to said threaded rod 7, to prevent said magnetic elements 4 from rotating freely. Continuing with FIG. 3, said fixing plates 5 have a number of holes that can house bolting elements inserted into the surface to be decorated.

Returning to FIG. 1, in order to prevent the main body 1 from accidently detaching from its position attached to the magnetic means, support means attached to the surface to be decorated have been provided, having being provided on the ends of the main body 1, such that said main body 1 remains locked in position. Said support means have a skirting 8 attached to the surface to be decorated with a plurality of bolting elements, each skirting 8 can have a trim element 9 snapped in place on its front side. It should be noted that said skirtings 8 are installed on both vertical and horizontal ends of the main body 1, as depending on the dimensions or the embossing of the surface to be decorated, it is not possible to cover the entire surface with a single main body 1, but rather with several bodies. Additionally, and to correct possible misalignments during assembly, the distance of said skirtings 8 can be adjusted relative to the surface to be decorated.

As seen in FIG. 1, the main body 1 makes contact with each skirting 8. The skirting 8 located at the bottom of the main body 1 is oversized relative to the skirting 8 at the top, as it has to bear a greater proportion of the total weight of the main body 1.

Imperfections on the surface to be decorated can make the main body 1 displace excessively relative to the skirtings 8. To ensure that the main body 1 always maintain optimum contact with the skirtings 8, said metal sheet 3 has a number of laminar appendages 10 at its ends, and perpendicular to the main body, such that the contact surface between the main body 1 and said skirtings 8 increases.

Advantageously, said main body may have a plurality of holes (not shown) configured to allow the butt ends of the service conduits to pass through. Therefore, it will be possible to freely choose the arrangement of elements such as taps or toilets. The installer can freely configure a service network arranged in the interior space formed by the main body 1 and the surface to be decorated, such that the service conduits will not be visible and an excellent visual appearance is achieved.

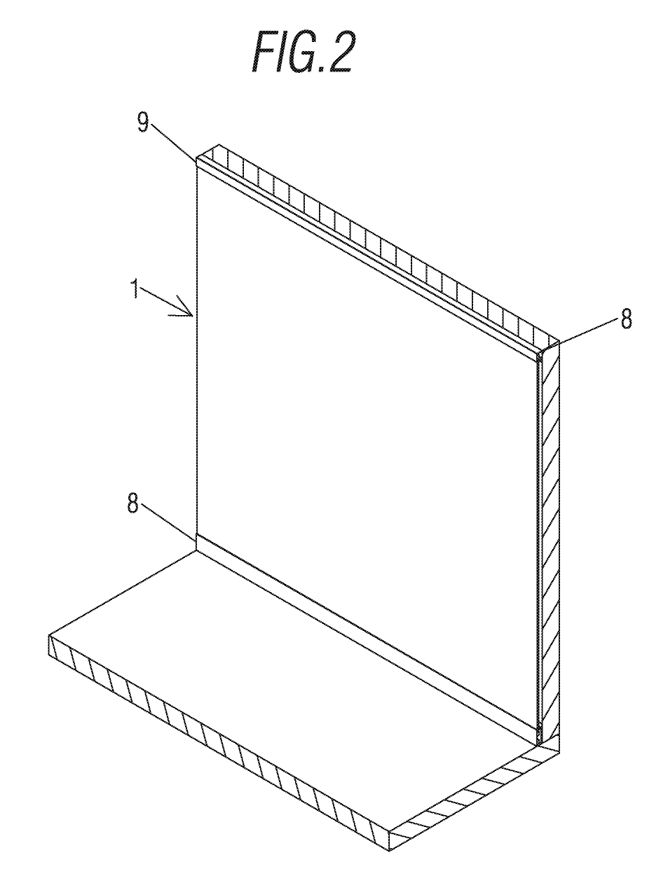

FIG. 2 illustrates a perspective view of an application of the ornamental attachment device according to the invention.

The details, shapes and dimensions and other accessory elements as well as the materials used in the manufacture of the ornamental attachment device of the invention may be conveniently replaced by others which are technically equivalent and do not depart from the essential nature of the invention or from the scope defined by the claims provided hereinafter.

1. Ornamental attachment device that can be used in particular on flat surfaces, comprising a main body that has at least one ornamental sheet and one metal sheet joined to each other on one of the sides thereof, said main body being joined in a detachable manner to a magnetic attachment structure arranged on a surface to be decorated, a supporting structure fixed to the surface to be decorated, the supporting structure being disposed on the ends of the main body such that said main body remains locked in position, wherein said magnetic attachment structure has a plurality of magnetic elements suitable for attaching to the surface to be decorated, each one of said magnetic elements being connected to the respective fixing plates by an adjustable threaded rod, such that a permanent contact is maintained between the main body and the magnetic elements.

2. Ornamental attachment device according to claim 1, wherein said ornamental sheet is made of laminated glass, corian or marble.

3. Ornamental attachment device according to claim 1, wherein said metal sheet is made of a ferric material.

4. Ornamental attachment device according to claim 1, wherein said metal sheet has a number of laminar appendages at its ends, perpendicular to the main body such that the contact surface between the main body and said supporting structure increases.

5. (canceled)

6. Ornamental attachment device according to claim 1, wherein said fixing plates have at least one hole that can house a bolting element.

7. Ornamental attachment device according to claim 1, wherein said supporting structure comprise at least one skirting fixed to the surface to be decorated with a plurality of bolting elements.

8. Ornamental attachment device according to claim 7, wherein said skirting has a trim element snapped in place on its front side.

9. Ornamental attachment device according to claim 1, wherein said main body has a plurality of holes configured such as to allow butt ends of the service conduits to pass through.

10. Ornamental attachment device according to claim 1, said main body is configured such as to allow service conduits to pass between the same main body and the surface to be decorated.
